(19) United States
(12) Patent Application Publication
(10) Pub. No.: US 2010/0013844 A1
(43) Pub. Date: Jan. 21, 2010

(54) MEMORY AND PIXEL DATA STORING METHOD

(75) Inventor: Cheng-Nan Lin, Hsinchu City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: RAYDIUM SEMICONDUCTOR CORPORATION, Hsinchu (TW)

(21) Appl. No.: 12/269,167

(22) Filed: Nov. 12, 2008

(30) Foreign Application Priority Data
Jul. 16, 2008 (TW) 97127040

(51) Int. Cl. G06F 12/02

(52) U.S. Cl. 345/543

(57) ABSTRACT

A memory includes at least one memory cell. The memory cell includes a first set of bits and a second set of bits for respectively storing first sub-pixel data and second sub-pixel data of pixel data. The first set of bits has a first fail bit. A least significant bit of the first sub-pixel data is stored at the first fail bit.

This application claims the benefit of Taiwan application Serial No. 97127040, filed Jul. 16, 2008, the subject matter of which is incorporated herein by reference.

### BACKGROUND OF THE INVENTION

1. Field of the Invention

The invention relates in general to a memory and a pixel data storing method, and more particularly to a memory for storing pixel data and a pixel data storing method.

2. Description of the Related Art

Errors or failure may often be caused in the processes of manufacturing a memory so that a logic value of a certain bit is always equal to 0 (stuck-at-0) or equal to 1 (stuck-at-1). Consequently, the pixel data before being stored into the memory is different from that after being stored into the memory.

In order to overcome this drawback, a column of memory positions, a row of memory positions or a block of memory positions is added to the conventional memory, which has original memory positions. Thus, the data is stored into the column where the fail bits fall, the data is stored into the row where the fail bits fall, or the data is stored at the original memory positions. However, the storing method has to be achieved by the additional memory, and the cost is significantly increased.

### SUMMARY OF THE INVENTION

The invention is directed to a memory and a pixel data storing method of storing a least significant bit of pixel data at a fail bit. Thus, the stored pixel data may approximate to the pixel data before being stored without adding the memory space so that the cost can be advantageously decreased.

According to a first aspect of the present invention, a memory including at least one memory cell is provided. The memory cell includes a first set of bits and a second set of bits for respectively storing first sub-pixel data and second sub-pixel data of pixel data. The first set of bits has a first fail bit, and a least significant bit of the first sub-pixel data is stored at the first fail bit.

According to a second aspect of the present invention, a pixel data storing method adapted to a memory is provided. The memory includes at least one memory cell, which includes a first set of bits and a second set of bits for respectively storing first sub-pixel data and second sub-pixel data of pixel data. The first set of bits has a first fail bit. The pixel data storing method includes the step of: storing a least significant bit of the first sub-pixel data to the first fail bit.

The invention will become apparent from the following detailed description of the preferred but non-limiting embodiments. The following description is made with reference to the accompanying drawings.

The invention will become apparent from the following detailed description of the preferred but non-limiting embodiments. The following description is made with reference to the accompanying drawings.

### BRIEF DESCRIPTION OF THE DRAWINGS

FIG. 1 is a schematic illustration showing a first example of a memory according to an embodiment of the invention.

FIG. 2 is a graph showing a gray level versus a voltage in one example.

FIG. 3 is a schematic illustration showing a second example of a memory according to the embodiment of the invention.

FIG. 4 is a schematic illustration showing a third example of a memory according to the embodiment of the invention.

FIG. 5 is a schematic illustration showing a fourth example of a memory according to the embodiment of the invention.

FIG. 6 is a schematic illustration showing a fifth example of a memory according to the embodiment of the invention.

FIG. 7 is a flow chart showing an example of a pixel data storing method according to the embodiment of the invention.

### DETAILED DESCRIPTION OF THE INVENTION

A memory of the invention includes at least one memory cell. The memory cell includes a first set of bits and a second set of bits for respectively storing first sub-pixel data and second sub-pixel data of pixel data. The first set of bits has a first fail bit. A least significant bit of the first sub-pixel data is stored in the first fail bit. The embodiment will be described in the following.

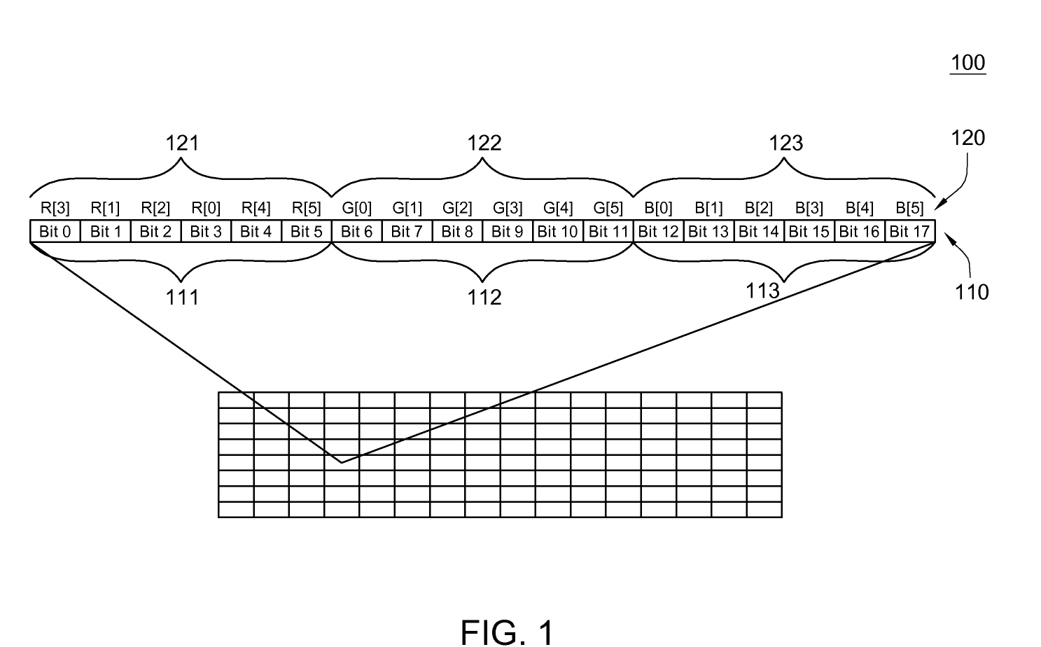

FIG. 1 is a schematic illustration showing a first example of a memory 100 according to an embodiment of the invention. Referring to FIG. 1, the memory 100 includes a memory cell 110 for storing pixel data 120. The pixel data 120 includes first sub-pixel data 121, second sub-pixel data 122 and third sub-pixel data 123. In this embodiment, the first sub-pixel data 121, the second sub-pixel data 122 and the third sub-pixel data 123 are respectively a red gray level, a green gray level and a blue gray level of the pixel data 120.

Each of the first sub-pixel data 121, the second sub-pixel data 122 and the third sub-pixel data 123 has m bits of data. In this embodiment, the first sub-pixel data 121 has 6 bits of data R[0] to R[5], the second sub-pixel data 122 has 6 bits of data G[0] to G[5], and the third sub-pixel data 123 has 6 bits of data B[0] to B[5], for example. R[0] is the least significant bit of the first sub-pixel data 121, G[0] is the least significant bit of the second sub-pixel data 122, and B[0] is the least significant bit of the third sub-pixel data 123.

The memory cell 110 includes a first set of bits 111, a second set of bits 112 and a third set of bits 113 for respectively storing the first sub-pixel data 121, the second sub-pixel data 122 and the third sub-pixel data 123 of the pixel data 120. Each of the first set of bits 111, the second set of bits 112 and the third set of bits 113 has m bits. In this embodiment, the first set of bits 111 has 6 bits, which are respectively bit 0 to bit 5, the second set of bits 112 has 6 bits, which are respectively bit 6 to bit 11, and the third set of bits 113 has 6 bits, which are respectively bit 12 to bit 17, for example. Bit 0 to bit 5 respectively correspond to R[0] to R[5], bit 6 to bit 11 respectively correspond to G[0] to G[5], and bit 12 to bit 17 respectively correspond to B[0] to B[5].

In this embodiment, the first set of bits 111 has a fail bit. The fail bit may be, for example, the failure or error generated in the processes of manufacturing the memory 100 so that the logic value of this bit is stuck-at-0 or stuck-at-1. As shown in FIG. 1, when the fail bit exists in the bit 3 of the first set of bits 111, the least significant bit R[0] of the first sub-pixel data 121 is stored in the fail bit (i.e., bit 3). In addition, the bit data R[3] corresponding to the fail bit (i.e., bit 3) in this embodiment is stored at the bit (i.e., bit 0) corresponding to the least significant bit R[0] of the first sub-pixel data 121.

That is, the bit data R[0] is stored at the bit 3, the bit data R[3] is stored at the bit 0, the bit data R[1], R[2], R[4], R[5], G[0] to G[5] and B[0] to B[5] are respectively stored in the bit 1, bit 2, bit 4, bit 5, bit 6 to bit 11 and bit 12 to bit 17.

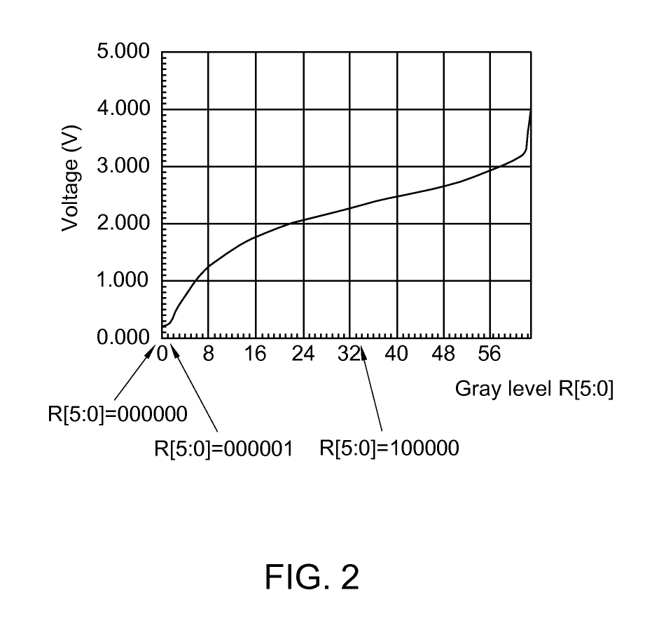

FIG. 2 is a graph showing a gray level versus a voltage in one example. As shown in FIG. 2, the X axis represents the gray level of the pixel data, such as the red gray level R[5:0] having 6 bits of data, wherein R[5] is the most significant bit and R[0] is the least significant bit. In addition, the Y axis represents the driving voltage corresponding to the gray level. As shown in FIG. 2, the driving voltage of the gray level 0 (R[5:0]=000000₂) is 0.2V the driving voltage of the gray level 1 (R[5:0]=000001₂) is 0.3V, and the driving voltage of the gray level 32 (R[5:0]=100000₂) is 2.3V. When the gray level is changed from 0 (R[5:0]=000000₂) to 1 (R[5:0]=000001₂), the least significant bit R[0] is changed from 0 to 1, and the driving voltage is increased by 0.1V (0.3V-0.2V). When the gray level is changed from 0 (R[5:0]=000000₂) to 32 (R[5:0]=100000₂), the most significant bit R[5] is changed from 0 to 1, and the driving voltage is increased by 2.1V (2.3V-0.2V). Consequently, the amplitude of change of the driving voltage caused when the least significant bit is changed is far smaller than the amplitude of change of the driving voltage caused when the most significant bit is changed. Thus, even if the stored first sub-pixel data 121 is not equal to the original first sub-pixel data 121, there is only the minor difference on the user's visual feeling.

In this embodiment, the least significant bit R[0] of the first sub-pixel data 121 of the pixel data 120 is stored in the fail bit (i.e., bit 3), which is stuck-at-0 or stuck-at-1. Consequently, when the first sub-pixel data 121 is read from the first set of bits 111, the obtained pixel value quite approximates to the first sub-pixel data 121 or even is equal to the first sub-pixel data 121. So, the stored first sub-pixel data 121 may approximate to the first sub-pixel data 121 before being stored so that the cost can be advantageously decreased without adding the additional memory to the memory 100 of the invention. Taking the bit 3 which is stuck-at-0 and the first sub-pixel data 121 which is 000101₂ as an example, the first sub-pixel data 121 is stored to the memory 100 of the invention, and the value thereof is read as 000100₂. Thus, the stored first sub-pixel data 121 (000100₂) quite approximates to the first sub-pixel data 121 (000101₂) before being stored.

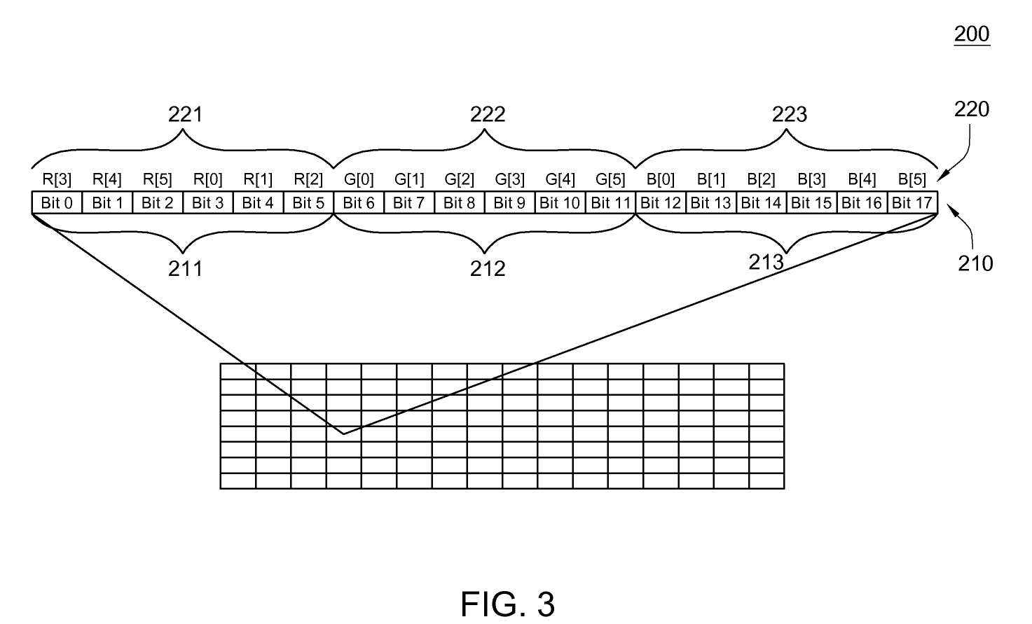

Although this embodiment is illustrated according to the example of swapping the stored position of the least significant bit R[0] of the first sub-pixel data 121 with the stored position of the bit data R[3] corresponding to the fail bit (i.e., bit 3), the invention is not limited thereto. FIG. 3 is a schematic illustration showing a second example of a memory 200 according to the embodiment of the invention. In the memory 200, the least significant bit R[0] of first sub-pixel data 221 is shifted to the fail bit (i.e., bit 3). That is, the 6 bits of data R[0] to R[5] of the first sub-pixel data 221 are sequentially stored at 6 bits of a first set of bits 211, that is, bit 3 to bit 5 and bit 0 to bit 2. In addition, the bit data G[0] to G[5] of second sub-pixel data 222 and the bit data B[0] to B[5] of third sub-pixel data 223 are stored at bit 6 to bit 11 and bit 12 to bit 17.

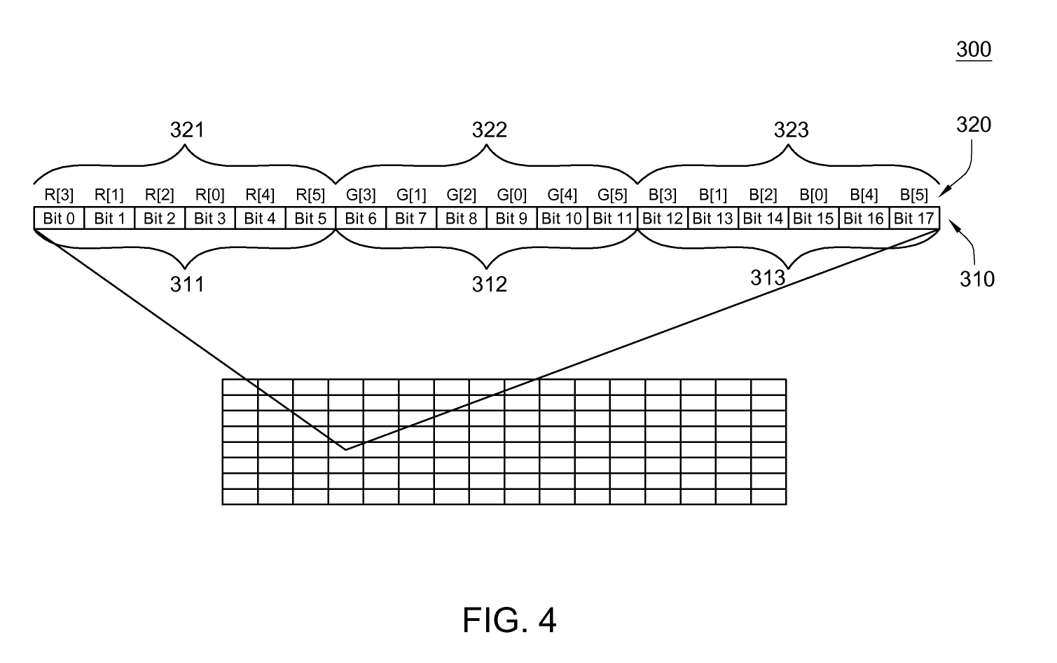

In addition, although the bit data G[0] to G[5] of the second sub-pixel data 122 and the bit data B[0] to B[5] of the third sub-pixel data 123 are stored at the bit 6 to bit 11 and the bit 12 to bit 17, the invention is not limited thereto. FIG. 4 is a schematic illustration showing a third example of a memory 300 according to the embodiment of the invention. In the memory 300, although a memory cell 310 only has a fail bit (i.e., bit 3), the bit data G[0] to G[5] of second sub-pixel data 322 and the bit data B[0] to B[5] of third sub-pixel data 323 are stored at a second set of bits 312 and a third set of bits 313 according a storing order of storing the bit data R[0] to R[5] of first sub-pixel data 321 at a first set of bits 311.

That is, the least significant bit G[0] of the second sub-pixel data 322 is stored at bit 9, and the least significant bit B[0] of the third sub-pixel data 323 is stored at bit 15. Furthermore, in the memory 300, the bit data R[3] is stored at bit 0, the bit data G[3] is stored at bit 6, the bit data B[3] is stored at bit 12, and the bit data R[1], R[2], R[4], R[5], G[1], G[2], G[4], G[5], B[1], B[2], B[4] and B[5] are respectively stored at bit 1, bit 2, bit 4, bit 5, bit 7, bit 8, bit 10, bit 11, bit 13, bit 14, bit 16 and bit 17. In another example, however, the bit data R[0] to R[5], G[0] to G[5] and B[0] to B[5] are stored at the first set of bits 311, the second set of bits 312 and the third set of bits 313 by way of shifting.

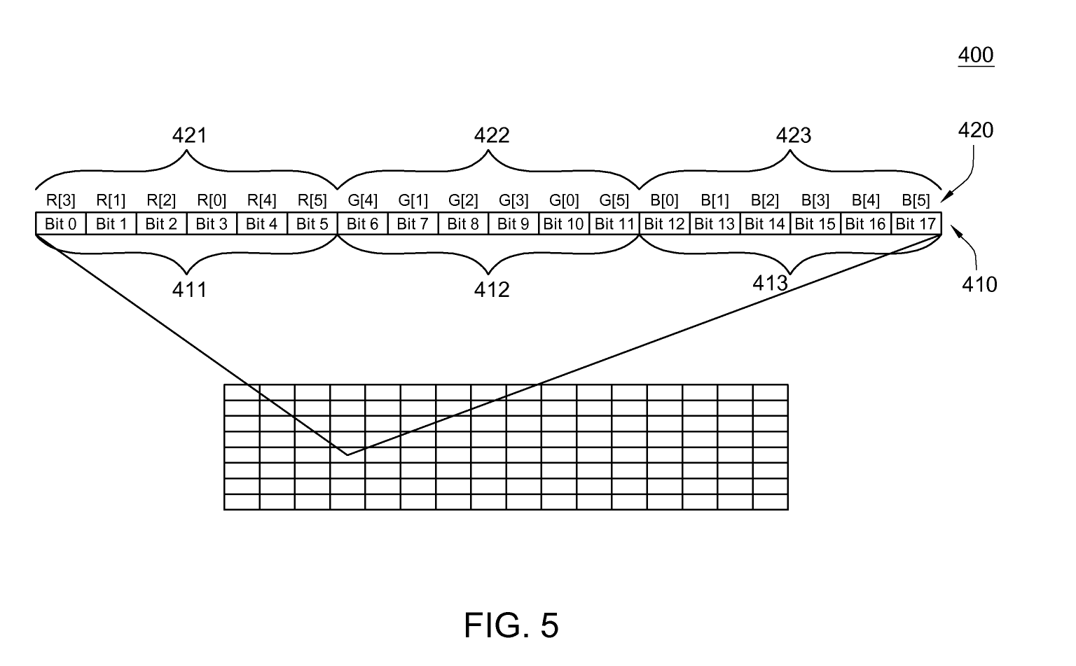

FIG. 5 is a schematic illustration showing a fourth example of a memory 400 according to the embodiment of the invention. As shown in FIG. 5, in the memory 400, a second set of bits 412 has another fail bit, such as bit 10, and the least significant bit G[0] of second sub-pixel data 422 is stored at the fail bit (i.e., bit 10). The bit data G[4] is stored at bit 6, and the bit data R[1], R[2], R[4], R[5], G[1], G[2], G[3], G[5] and B[0] to B[5] are respectively stored at bit 1, bit 2, bit 4, bit 5, bit 7, bit 8, bit 9 and bit 12 to bit 17.

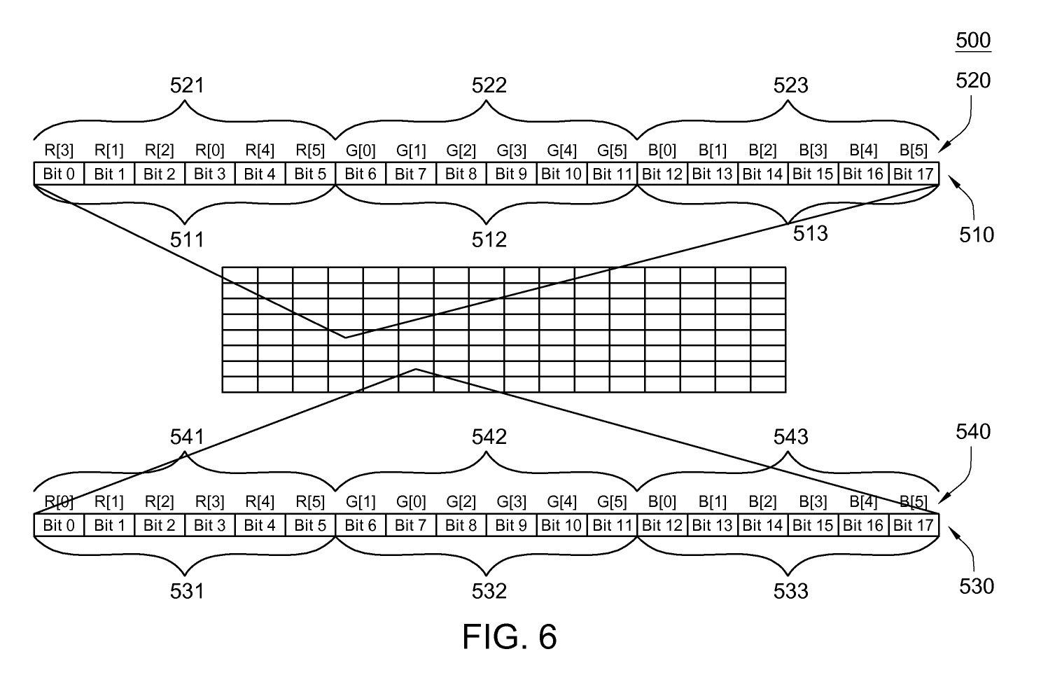

FIG. 6 is a schematic illustration showing a fifth example of a memory 500 according to the embodiment of the invention. Referring to FIG. 6, the memory 500 further includes another memory cell 530 for storing another pixel data 540. A second set of bits 532 of the memory cell 530 has another fail bit, such as bit 7. The least significant bit G[0] of second sub-pixel data 542 of the pixel data 540 is stored at the fail bit (i.e., bit 7) of the second set of bits 532 of the memory cell 530.

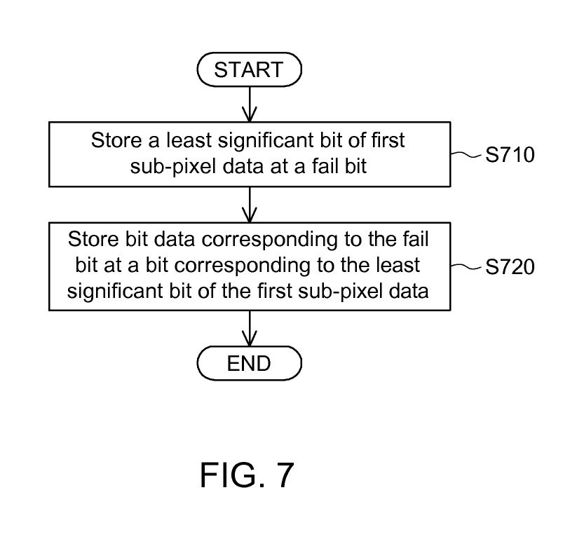

In addition, the invention also provides a pixel data storing method. FIG. 7 is a flow chart showing an example of the pixel data storing method according to the embodiment of the invention. The pixel data storing method of the invention is applied to, without limitation to, the memory 100 of FIG. 1. One of ordinary skill in the art may easily understand that the steps of and the order of the steps of the pixel data storing method may be modified and adjusted according to the actual application condition.

First, in step S710, the least significant bit R[0] of the first sub-pixel data 121 is stored at the fail bit (i.e., bit 3). Next, in step S720, the bit data R[3] corresponding to the fail bit (i.e., bit 3) is stored at the bit (i.e., bit 0) corresponding to the least significant bit R[0] of the first sub-pixel data 121. The operation principle of the pixel data storing method has been described in detailed in the memory 100, so detailed descriptions thereof will be omitted.

In the memory and the pixel data storing method according to the embodiment of the invention, the least significant bit of the pixel data is stored at the fail bit so that the pixel value obtained by reading the stored pixel data approximates to or is the same as the pixel data before being stored. Thus, there is only the minor difference on the user's visual feeling. Consequently, the memory of the invention can make the stored pixel data approximate to the pixel data before being stored without the additional memory space being added so that the cost can be advantageously decreased.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A memory, comprising:
at least one memory cell, which comprises a first set of bits and a second set of bits for respectively storing first sub-pixel data and second sub-pixel data of pixel data, wherein the first set of bits has a first fail bit, and a least significant bit of the first sub-pixel data is stored at the first fail bit.

2. The memory according to claim 1, wherein m bits of each of the sets of bits respectively correspond to m bits of data of each of the first and second sub-pixel data, m is a positive integer, and bit data corresponding to the first fail bit is stored at a bit corresponding to the least significant bit of the first sub-pixel data.

3. The memory according to claim 1, wherein m bits of data of the first sub-pixel data are sequentially stored at m bits of the first set of bits, and m is a positive integer.

4. The memory according to claim 1, wherein m bits of data of the second sub-pixel data are stored at the second set of bits according to a storing order of storing m bits of data of the first sub-pixel data to the first set of bits, and m is a positive integer.

5. The memory according to claim 1, wherein the second set of bits has a second fail bit, and a least significant bit of the second sub-pixel data is stored at the second fail bit.

6. The memory according to claim 1, further comprising another memory cell, which comprises a first set of bits and a second set of bits for respectively storing first sub-pixel data and second sub-pixel data of another pixel data, and the second set of bits of the pixel data has a second fail bit,
wherein the least significant bit of the second sub-pixel data of the another pixel data is stored at the second fail bit of the second set of bits of the another memory cell.

7. The memory according to claim 1, wherein the first sub-pixel data is a red gray level, a green gray level or a blue gray level of the pixel data.

8. A pixel data storing method adapted to a memory, the memory comprising at least one memory cell, which comprises a first set of bits and a second set of bits for respectively storing first sub-pixel data and second sub-pixel data of pixel data, the first set of bits having a first fail bit, the pixel data storing method comprising the step of:
storing a least significant bit of the first sub-pixel data to the first fail bit.

9. The method according to claim 8, wherein m bits of each of the sets of bits respectively correspond to m bits of data of each of the first and second sub-pixel data, m is a positive integer, and the pixel data storing method further comprises the step of:
storing bit data corresponding to the first fail bit at a bit corresponding to the least significant bit of the first sub-pixel data.

10. The method according to claim 8, further comprising the step of:
sequentially storing m bits of data of the first sub-pixel data at m bits of the first set of bits, wherein m is a positive integer.

11. The method according to claim 8, further comprising the step of:
storing m bits of data of the second sub-pixel data at the second set of bits according to a storing order of storing m bits of data of the first sub-pixel data to the first set of bits, wherein m is a positive integer.

12. The method according to claim 8, wherein the second set of bits has a second fail bit, and the pixel data storing method further comprises the step of:
storing a least significant bit of the second sub-pixel data at the second fail bit.

13. The method according to claim 8, wherein:
the memory further comprises another memory cell, which comprises a first set of bits and a second set of bits for respectively storing first sub-pixel data and second sub-pixel data of another pixel data, and the second set of bits of the pixel data has a second fail bit; and
the pixel data storing method further comprises the step of: storing the least significant bit of the second sub-pixel data of the another pixel data at the second fail bit of the second set of bits of the another memory cell.

14. The method according to claim 8, wherein the first sub-pixel data is a red gray level, a green gray level or a blue gray level of the pixel data.
